(19) United States
(12) Patent Application Publication
(10) Pub. No.: US 2015/0100464 A1
(43) Pub. Date: Apr. 9, 2015

(54) INFORMATION DISPLAYING APPARATUS AND METHOD OF OBJECT

(71) Applicant: UTECHZONE CO., LTD., New Taipei City (TW)

(72) Inventors: Chia-Chun Tsou, New Taipei City (TW); Yi-Fan Chen, New Taipei City (TW); Chieh-Yu Lin, New Taipei City (TW)

(73) Assignee: UTECHZONE CO., LTD., New Taipei City (TW)

(21) Appl. No.: 14/166,861

(22) Filed: Jan. 29, 2014

(30) Foreign Application Priority Data
Oct. 9, 2013 (TW) 102136567

(51) Int. Cl. G06Q 30/06

(52) U.S. Cl. CPC G06Q 30/0643
USPC 705/27.2

(57) ABSTRACT

During shopping, a customer usually needs a shop clerk to provide a consulting service for understanding product information. However, a selling approach of the shop clerk may cause the customer to feel pressure. Moreover, due to the limited space, it is impossible to lay out all products in the store for the customer's selection. An information displaying apparatus for objects and a method thereof, provided by the invention, detect an operation of the customer by a motion detector and display an interactive image corresponding to the operation by a screen for providing abundant product information. Accordingly, the information displaying apparatus displays all products and sufficient product information in a limited space, and creates a relaxing and convenient shopping environment for increasing the customer's desire to purchase.

### CROSS-REFERENCE TO RELATED APPLICATION

This application claims the priority benefit of Taiwan application serial no. 102136567, filed on Oct. 9, 2013. The entirety of the above-mentioned patent application is hereby incorporated by reference herein and made a part of this specification.

### BACKGROUND OF THE INVENTION

1. Field of the Invention

The invention relates to an information displaying method and particularly relates to an information displaying apparatus for objects and an information displaying method thereof executed by a somatosensory operation.

2. Description of Related Art

Thanks to the development and convenience of on-line shopping, consumers are not required to go out for shopping. However, on-line shopping websites usually cannot provide abundant product information and adequate knowledge of sales. As a result, many consumers prefer shopping in person at physical stores. When consumers go to the stores for shopping, a selling approach of the shop clerk may cause the consumers to feel pressure and reduce the consumers' desire to purchase. In addition, although some consumers may enjoy communicating with the shop clerk to fully understand the product information, the service time of the shop clerk is limited and cannot take into account all consumers.

For the stores offering the products, since the stores may have limited space, they usually cannot lay out all their products in the stores for consumers' selection. Furthermore, in order to meet the consumers' demand, new products are introduced faster than before. For this reason, the shop clerk may not be able to provide the latest product information. Therefore, the stores need a more efficient way for sales.

### SUMMARY OF THE INVENTION

The invention provides an information displaying apparatus and an information displaying method, which provide a consumer sufficient product information and create a relaxing and convenient shopping environment to increase the consumer's desire to purchase.

The invention provides an information displaying apparatus for objects, and the information displaying apparatus includes a first screen, a motion detector, a storage unit, and a processor. The storage unit includes a database that has a variety of information about a plurality of objects therein. The processor is coupled to the first screen, the motion detector, and the storage unit, wherein the first screen displays any number of the objects in the database; the motion detector detects a first operation action of the user; and the processor displays an interactive image corresponding to the first operation action via the first screen according to the first operation action, determines whether the first operation action is to select a specific object among the objects, and searches the database according to the specific object to display information about the specific object via the first screen.

In an embodiment of the invention, the information about the specific object includes one of object composition, object utility, production place of object, promotional activity, and corporate vision, or a combination of the foregoing.

In an embodiment of the invention, the first screen displays the information about the specific object by a plurality of pages.

In an embodiment of the invention, the motion detector detects a second operation action of the user, and the processor opens or reduces a first page that is being reviewed by the user via the first screen according to the second operation action.

In an embodiment of the invention, the first screen displays a perspective image of the specific object, and the processor displays and rotates the perspective image of the specific object according to the second operation action detected by the motion detector.

In an embodiment of the invention, the processor further displays a virtual clerk via the first screen according to the specific object for providing a consulting service regarding the specific object.

In an embodiment of the invention, the information displaying apparatus further includes a physical counter. An operator at the physical counter serves clients through the virtual clerk displayed by the information displaying apparatus.

In an embodiment of the invention, a plurality of the information displaying apparatuses are disposed in a row; a plurality of physical counters are respectively disposed between part of the information displaying apparatuses; the processor of each of the information displaying apparatuses displays a virtual clerk via the first screen thereof; and a clerk at one of the physical counters undertakes the consulting service from the virtual clerk and continues to provide sales services regarding the specific object according to the information about the specific object provided by the information displaying apparatus.

In an embodiment of the invention, the processor further displays payment information related to the specific object via the first screen. The information displaying apparatus further includes: a payment device and an object delivery portion. The payment device is adapted for collecting money. The processor determines whether an amount of a payment made by the user is greater than or equal to a price of the specific object and outputs the specific object to the object delivery portion.

In an embodiment of the invention, the information displaying apparatus further includes a network unit. The information displaying apparatus is connected to a network by the network unit to obtain the information about the specific object, and the information about the specific object is stored in the database.

From another aspect, the invention provides an information displaying method for objects, and the information displaying method includes the following steps. A plurality of objects are displayed via a first screen, wherein a variety of information about the objects is stored in a database. A first operation action of a user is detected by a motion detector. An interactive image corresponding to the first operation action is displayed via the first screen according to the first operation action. Whether the first operation action is to select a specific object among the objects is determined. The database is searched to display information about the specific object via the first screen.

In an embodiment of the invention, the information about the specific object includes one of object composition, object utility, production place of object, promotional activity, and corporate vision, or a combination of the foregoing.

In an embodiment of the invention, a step of displaying the information about the specific object includes the following steps. The information about the specific object is displayed by a plurality of pages via the first screen.

In an embodiment of the invention, after the step of displaying the information about the specific object, the information displaying method further includes the following steps. A second operation action of the user is detected. A first page that is being reviewed by the user is opened or reduced via the first screen according to the second operation action.

In an embodiment of the invention, after a step of detecting the second operation action of the user, the information displaying method further includes the following steps. A perspective image of the specific object is displayed. Moreover, the perspective image is displayed and rotated according to the second operation action detected by the motion detector.

In an embodiment of the invention, after the step of displaying the information about the specific object, the information displaying method further includes the following steps. A virtual clerk is displayed via the first screen according to the specific object for providing a consulting service regarding the specific object.

In an embodiment of the invention, after the step of displaying the information about the specific object, the information displaying method further includes the following steps. The virtual clerk displayed by an information displaying apparatus is provided so that an operator at a physical counter serves clients through the virtual clerk.

In an embodiment of the invention, a plurality of information displaying apparatuses are disposed in a row and a plurality of physical counters are respectively disposed between part of the information displaying apparatuses, and the information displaying method further includes the following steps after a step of displaying the information about the specific object by the information displaying apparatuses. A virtual clerk is displayed via the first screen. A clerk at one of the physical counters undertakes the consulting service from the virtual clerk and provides sales services regarding the specific object according to the information about the specific object provided by the information displaying apparatus.

In an embodiment of the invention, after the step of displaying the information about the specific object, the information displaying method further includes the following steps. Payment information related to the specific object is displayed. Money is collected by a payment device. Whether an amount of a payment made by the user is greater than or equal to a price of the specific object is determined, and whether to output the specific object is determined according to a result of the aforementioned determination.

In an embodiment of the invention, the information displaying method further includes the following steps before a step of searching the database. A network is connected to obtain the information about the specific object. Moreover, the information about the specific object is stored in the database.

Based on the above, the information displaying apparatus described in the embodiments of the invention displays multiple objects/products for the user's selection and detects the selection operation of the user to display interactive images and display a variety of information about the selected object, e.g. product composition, utility, production place, promotional activity and/or brand name/corporate vision, etc. Therefore, the consumer is able to review all the products to obtain sufficient product information through the information displaying apparatus of the invention. Moreover, the pressure the consumer feels is reduced, and thus the consumer can shop at ease.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a block diagram illustrating an information displaying apparatus for objects according to an embodiment of the invention.

FIG. 2 is a schematic diagram of an information displaying apparatus according to an embodiment of the invention.

FIG. 3 is a flowchart illustrating an information displaying method for objects according to an embodiment of the invention.

FIG. 4 is a schematic diagram illustrating a display of objects according to an embodiment of the invention.

FIG. 5 is a schematic diagram illustrating a user executing an operation action on a first screen according to an embodiment of the invention.

FIG. 6 is a schematic diagram illustrating a display of information about a specific object according to an embodiment of the invention.

FIG. 7 is a schematic diagram illustrating multiple pages displaying information about a specific object according to an embodiment of the invention.

FIG. 8 is a schematic diagram illustrating a collected page according to an embodiment of the invention.

FIG. 9A and FIG. 9B are schematic diagrams illustrating perspective images according to an embodiment of the invention.

FIG. 10 is a schematic diagram illustrating an information displaying apparatus according to another embodiment of the invention.

FIG. 11 is a schematic diagram illustrating a combination of an information displaying apparatus and a physical counter according to an embodiment of the invention.

FIG. 12 is a schematic diagram illustrating an information displaying apparatus according to another embodiment of the invention.

FIG. 13A and FIG. 13B are schematic diagrams illustrating a combination of an information displaying apparatus and a physical counter according to another embodiment of the invention.

### DESCRIPTION OF THE EMBODIMENTS

In order that a consumer can receive abundant product information during shopping, embodiments of the invention provide an information displaying apparatus and an information displaying method for objects. The information displaying apparatus has a first screen and a motion detector. The first screen displays a plurality of objects for the user to review. The motion detector detects a selection operation of the user so as to display an interactive image by the first screen, and the first screen displays a variety of information about the object selected by the user according to the selection operation. Thus, the consumer does not need to worry that he/she cannot see all the products to obtain sufficient product information and therefore can shop at ease. Embodiments conforming to the spirit of the invention are provided below for reference. Nevertheless, it should be noted that the invention is not limited to the below-described embodiments.

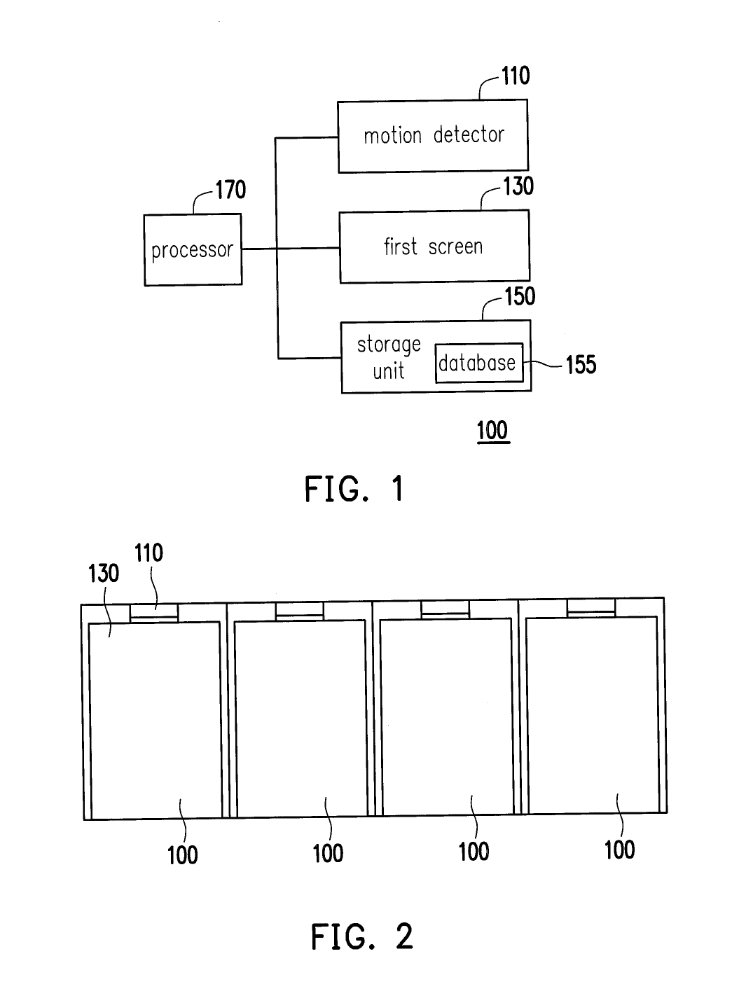

FIG. 1 is a block diagram illustrating an information displaying apparatus according to an embodiment of the invention. With reference to FIG. 1, an information displaying apparatus 100 includes a motion detector 110, a first screen 130, a storage unit 150, and a processor 170. The motion detector 110 may be a depth camera, a stereo camera, a RGB camera, or a combination of the foregoing. The first screen 130 may be a display device, such as a liquid crystal display (LCD), an organic electro-luminescent display (OELD), or a plasma display panel (PDP), etc. The storage unit 150 includes a database 155, which includes a variety of information about a plurality of objects (e.g. information about object composition, object utility, production place of the object, etc.). The processor 170 is coupled to the first screen 130, the motion detector 110, and the storage unit 150. The processor 170 may be a chip set, a microprocessor, or a micro control unit (MCU) that has an operation function.

In an embodiment of the invention, the consumer goes to a store in order to receive sufficient product information. The shop clerk tries his/her best to sell products offered by the store but instead causes the consumer to feel pressure and reduce the consumer's desire to purchase. In addition, the store (a physical store) has very limited space and cannot display all products in the store. For example, clothes of the same style may be offered in a variety of colors, but the store may display only certain colors or styles at the window due to limited display space and keep the clothes of other colors in the warehouse. As a result, it is difficult for the consumer to see all the colors and patterns to immediately determine whether the products meet their needs, resulting in that the store cannot sell the products successfully. Therefore, in order to provide sufficient product information to the consumer and create a relaxing environment for the consumer, the motion detector 110 in the information displaying apparatus 100 of the embodiment of the invention detects an operation of the consumer to display an interactive image on the first screen 130 so as to display the product selected by the consumer and the relevant information according to the consumer's operation. Accordingly, the consumer's needs are met to increase the consumer's desire to purchase.

FIG. 2 is a schematic diagram of an information displaying apparatus according to an embodiment of the invention. With reference to FIG. 2, a plurality of information displaying apparatuses 100 are arranged in a row. For example, each of the information displaying apparatuses 100 is like a small store, and each user may use the information displaying apparatus 100 individually. The information displaying apparatuses 100 may be separated from each other by a board, etc., considering the user's privacy. The motion detector 110 is disposed above the information displaying apparatus 100. However, the motion detector of the invention may also be disposed on the right or the left side of the information displaying apparatus 100 or be embedded in any position of the first screen 130. This disclosure is not intended to limit the position of the motion detector of the invention. The first screen 130 is used to display an image.

Below an information displaying method for objects in an embodiment of the invention, for providing the consumer sufficient product information to increase the consumer's desire to purchase, is described in detail.

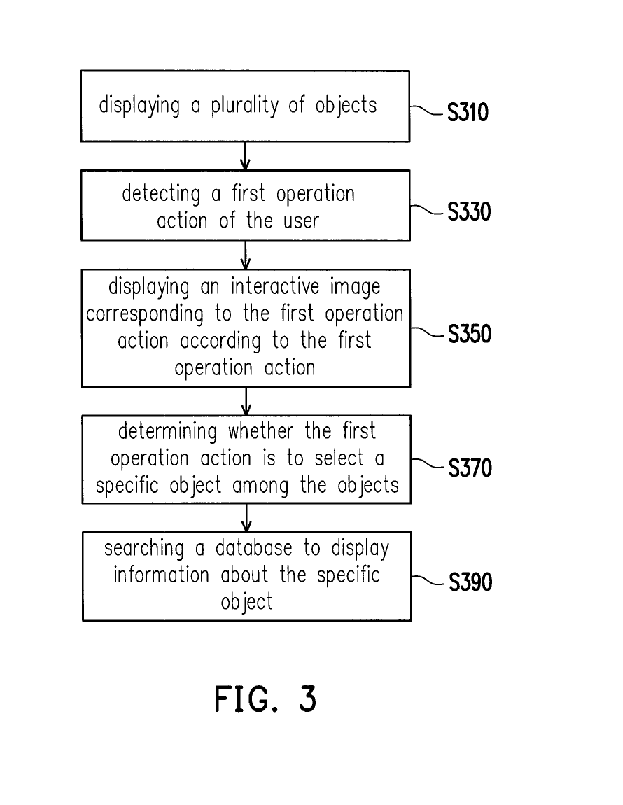

FIG. 3 is a flowchart illustrating an information displaying method for objects according to an embodiment of the invention. Referring to FIG. 3, the information displaying method of this embodiment is adapted for the information displaying apparatus of FIG. 1. In the following paragraphs, reference will be made to the elements of the information displaying apparatus 100 of FIG. 1 for describing the information displaying method of this embodiment. Steps of the information displaying method may be adjusted according to the situation of implementation, and the invention is not limited thereto.

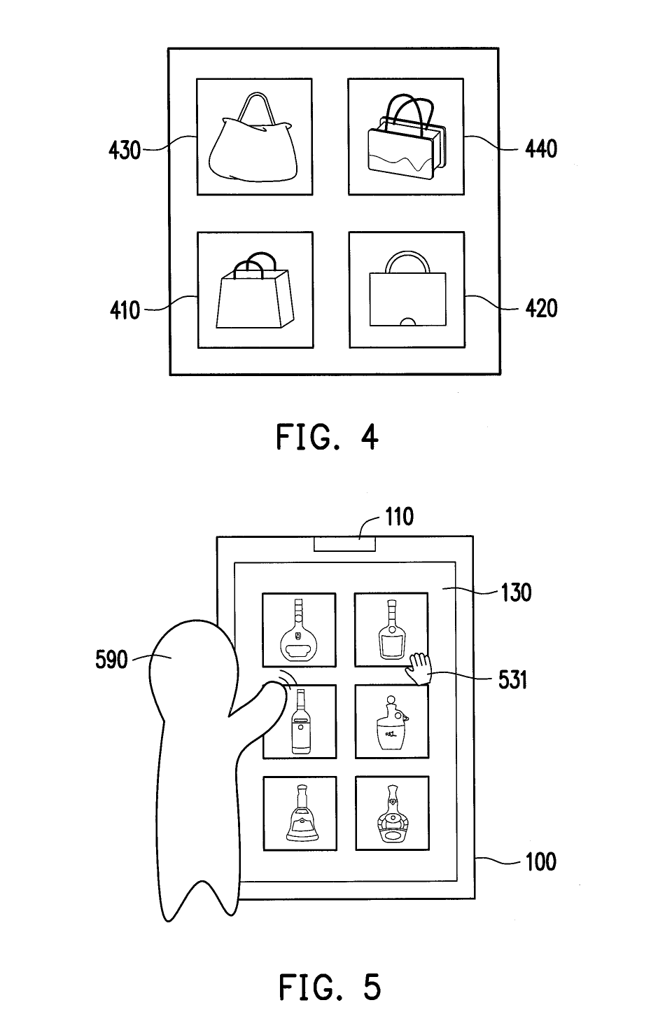

In Step S310, a plurality of objects are displayed by the first screen 130, wherein a variety of information about the objects is stored in the database 155. For example, FIG. 4 is a schematic diagram illustrating a display of objects according to an embodiment of the invention. With reference to FIG. 4, pictures of four objects 410, 420, 430, and 440 are displayed in the image of the first screen 130. In this embodiment, the objects are displayed in the form of pictures in the image of the first screen 130. However, the objects may also be presented in a text description, an advertisement image, a 360 degree rotatable video of the object, etc. Moreover, the positions, number, and sizes of the objects 410, 420, 430, and 440 are not limited to the above example.

With reference to FIG. 3, in Step S330, a first operation action of the user is detected by the motion detector 110. The operation action may be swinging an arm or opening a palm, etc., for example. In Step S350, the processor 170 displays an interactive image corresponding to the first operation action via the first screen 130 according to the first operation action. For instance, FIG. 5 is a schematic diagram illustrating the user executing an operation action on the first screen according to an embodiment of the invention. With reference to FIG. 5, the information displaying apparatus 100 includes the motion detector 110 and the first screen 130. The first screen 130 displays a plurality of objects. When a user 590 raises his/her arm, the motion detector 110 identifies a palm of the user 590 as a target object and starts detecting an operation action of a gesture of the user 590. A palm pattern 531 is also shown in the image of the first screen 130. The movement of the palm pattern 531 reflects the movement of the gesture of the user 590 detected by the motion detector 110. In this embodiment, the interactive image is not limited to reflecting the movement of the palm of the user. The interactive image may also be an image showing greetings such as “welcome” responsive to the user's waving hand or an image showing guiding instructions when the user performs no motion. The interactive image of the embodiment of the invention is not limited to the above examples.

With reference to FIG. 3, in Step S370, the processor 170 determines whether the first operation action is to select a specific object among the objects. For example, the processor 170 analyzes the first operation action by technical analysis, such as image identification or three-dimensional depth analysis, to obtain analytical data according to the first operation action detected by the motion detector 110 in Step S330, and the processor 170 compares the obtained analytical data according to an operation action comparison table in the storage unit 150. When the processor 170 determines that the analytical data indicates a selection action (e.g. when the five fingers of the user move inward to form a fist, the processor 170 determines such an operation action as selection), an operation of selecting the specific object in the image of the first screen 130 is executed correspondingly. In this embodiment of the invention, the steps by which the processor 170 determines the first operation action as the selection action are not limited to the above. The motion detector 110 may use any motion sensing technique to detect the first operation action.

In Step S390, the processor 170 searches the database 155 to display information related to the specific object via the first screen 130. More specifically, the database 155 stores a variety of information about a plurality of objects. When the processor 170 determines that the first operation action detected in Step S330 is to select a specific object, the processor 170 searches the database 155 according to the specific object to obtain information about the specific object, and displays the obtained information via the first screen 130.

Accordingly, the user is able to receive sufficient product information from the information displaying apparatus of this embodiment of the invention. Moreover, the store is able to present all products through the information displaying apparatus, thereby displaying various types of products in the limited space. Therefore, the user does not need to worry about problems, such as difficulty in finding all available colors of clothes of the same style or finding a coat of a specific size or pattern.

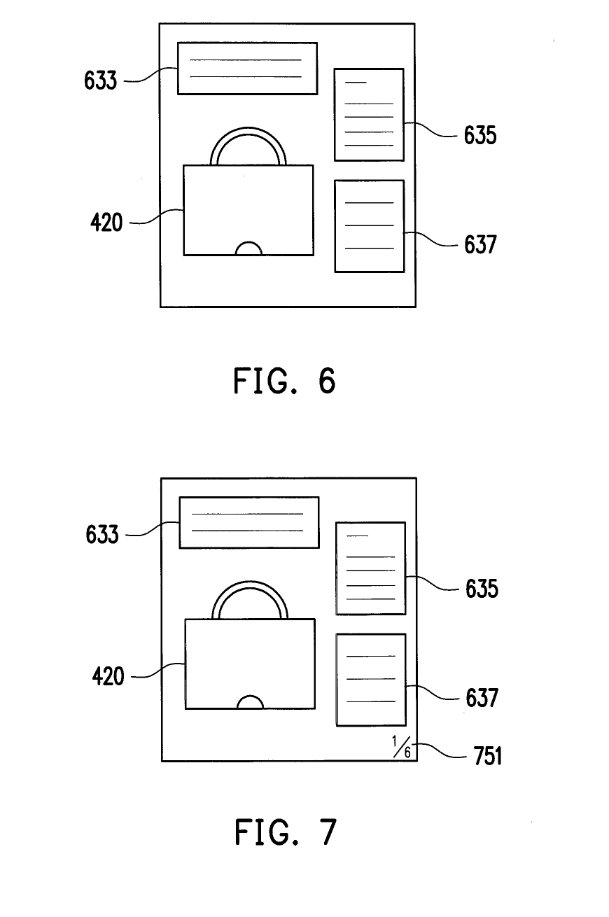

For example, FIG. 6 is a schematic diagram illustrating a display of information about a specific object according to an embodiment of the invention. With reference to FIG. 6, the user selects the object 420 of FIG. 4, and the processor 170 determines the object 420 as the specific object. As shown in FIG. 6, information 633, 635, and 637 about the object 420 is disposed beside the object 420. In this embodiment, the information about the specific object includes one of object composition, object utility, production place of object, promotional activity, and corporate vision, or a combination of the foregoing. The information 633, 635, and 637 may be presented in the form of text, picture, and video, etc. The position, number, and size of the information 633, 635, and 637 of this embodiment are not limited to the above example.

In an embodiment of the invention, the information displaying apparatus 100 may include a network unit, wherein the processor 170 connects to a network via the network unit to obtain the information about the specific object and stores the information in the database 155. For example, the database 155 has a comparison table including a link corresponding to each object (e.g. an official website of the company to which the object belongs, an evaluation information website of the object, and a promotion activity link of object, etc.). The processor 170 connects to the Internet according to this comparison table, so as to obtain the information about the specific object. The processor 170 may periodically connect to the Internet via the network unit to obtain the latest object information. Therefore, the information displaying apparatus is capable of obtaining the latest product information instantly, and the user does not need to worry about missing information, such as the latest discount messages and new arrivals.

In an embodiment of the invention, the first screen 130 displays the information about the specific object on a plurality of pages. For example, FIG. 7 is a schematic diagram illustrating multiple pages displaying information about a specific object according to an embodiment of the invention. With reference to FIG. 7, please refer to the example of FIG. 6 for descriptions of the object 420 and the information 633, 635, and 637 of FIG. 7. A difference between FIG. 7 and FIG. 6 is that a page label 751 in FIG. 7 indicates that there are six pages of information about the object 420, and the current page is page 1. The user may select other pages to receive more information about the object 420.

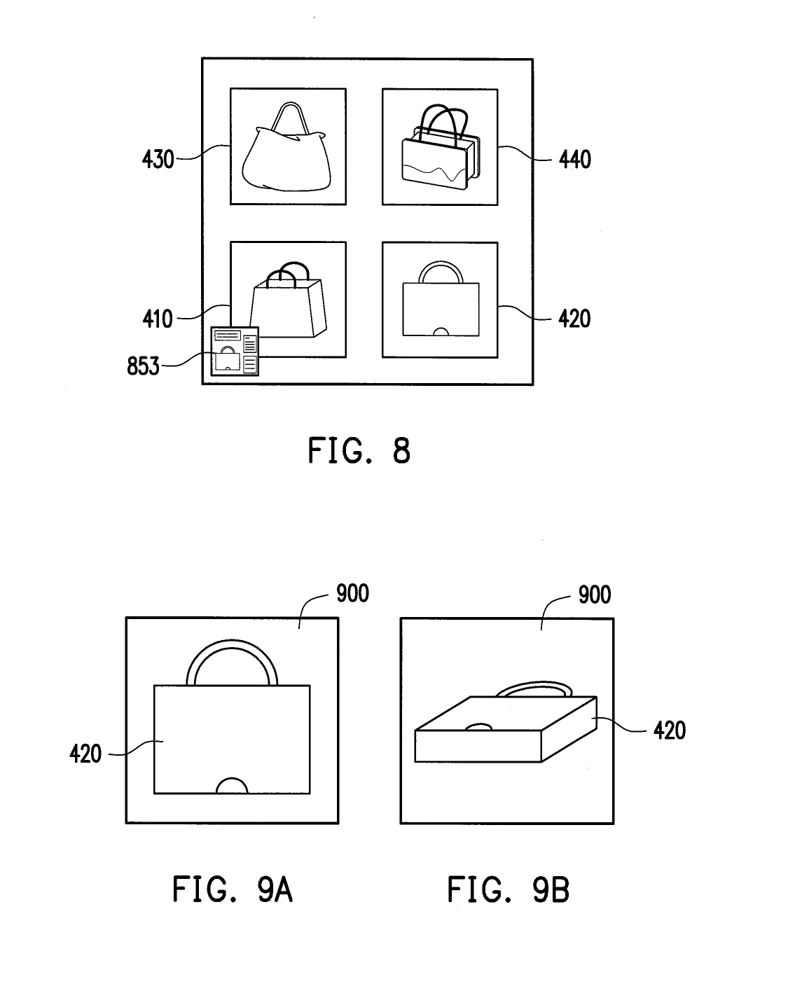

In addition, if the user is interested in the current page of FIG. 7 but wishes to review other objects as well, the user may collect the current page to be reviewed later. For example, FIG. 8 is a schematic diagram illustrating a collected page according to an embodiment of the invention. With reference to FIG. 7 and FIG. 8, the motion detector 110 detects a second operation action of the user, and the processor 170 opens or reduces the page 1 that is being reviewed by the user on the first screen 130 according to the second operation action. For instance, if the motion detector 110 detects that the second operation action of the user is to click a collection folder 853, the processor 170 determines the second operation action and then stores or reduces the current page to the collection folder 853 on the first screen 130 and displays the objects 410, 420, 430, and 440 as presented in FIG. 4. When the processor 170 again determines that the second operation action is to click the collection folder 853, the processor 170 opens the page stored in the collection folder 853 on the first screen 130 to display the page as shown in FIG. 7 again. Accordingly, the user is able to repeatedly review the page he/she is interested in easily. The first screen 130 may also display a pattern (e.g., a heart-shaped pattern) for the user to click for collecting pages. It should be noted that the steps of collecting pages in this embodiment of the invention are not limited to the above example.

Moreover, the object 420 in FIG. 4 may be a perspective image, such as a three-dimensional object (model) or a panoramic picture. In this embodiment, the first screen 130 displays a perspective image of the specific object, and the processor 170 displays and rotates the perspective image according to the second operation action detected by the motion detector 110. For example, FIG. 9A and FIG. 9B are schematic diagrams illustrating perspective images according to an embodiment of the invention. With reference to FIG. 9A, the first screen 130 displays a perspective image 900 of the object 420 in a first direction. When the processor 170 determines that the second operation action detected by the motion detector 110 is to rotate the perspective image 900, the first screen 130 displays that the perspective image 900 is rotated corresponding to the second operation action. With reference to FIG. 9B, the first screen 130 displays the perspective image 900 of the object 420 in a second direction corresponding to the second operation action of the user. In another embodiment of the invention, the information displaying apparatus 100 further includes a projector and the projector utilizes floating projection technology to present the perspective image 900 before the user.

In the above embodiments, the consumer is able to receive sufficient product information from the information displaying apparatus 100, and the processor 170 may further display a virtual clerk via the first screen 130 according to the specific object for providing a consulting service regarding the specific object.

For example, FIG. 10 is a schematic diagram illustrating an information displaying apparatus according to another embodiment of the invention. With reference to FIG. 10, an information displaying apparatus 1000 of FIG. 10 corresponds to the information displaying apparatus 100 of FIG. 2, and a difference therebetween lies in that, in FIG. 10, the first screen 130 not only displays the object 420 of FIG. 4 but also displays a virtual clerk 1070. The information displaying apparatus 1000 further includes a microphone 1010 and a speaker 1020. The microphone 1010 receives a voice of the user and transfers the voice to voice data to be transmitted to the processor 170. The processor 170 then performs voice recognition processing and causes the virtual clerk 1070 on the first screen 130 to execute a corresponding action. At the same time, the speaker 1020 plays a sound corresponding to the virtual clerk 1070. In other embodiments, the information displaying apparatus 1000 responds to a question of the user without the speaker 1020. In that case, the information displaying apparatus 1000 may respond by displaying text or figure via the first screen 130 directly. In addition, the first screen 130 may display a virtual keyboard for the user to input the question he/she wishes to ask. The virtual clerk of this embodiment of the invention may interact with the user by means of text, sound, or video. Thus, the invention is not limited to the above example.

Since the first screen 130 displays the virtual clerk 1070 to provide the consulting service, the consumer is able to directly communicate with the virtual clerk 1070 to obtain the information required quickly. In addition, the information displaying apparatus 1000 may also be combined with a physical counter, which provides services together with the virtual clerk 1070, so as to make a good impression on the consumer.

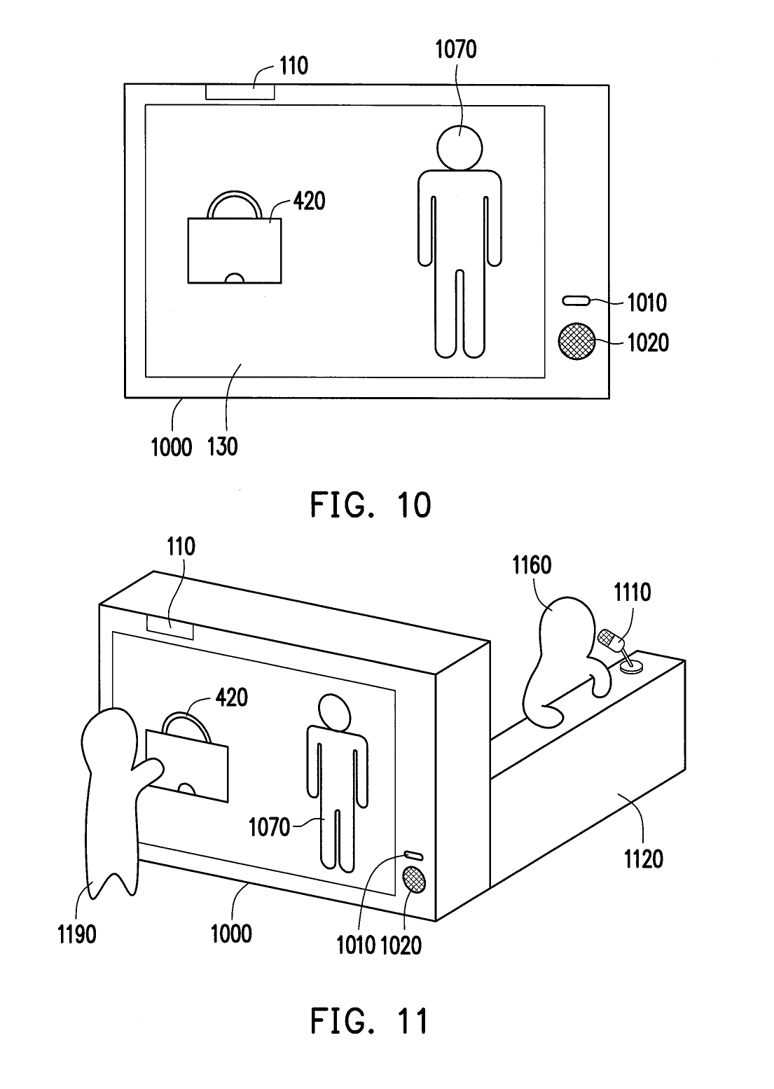

For example, FIG. 11 is a schematic diagram illustrating a combination of the information displaying apparatus 1000 and the physical counter according to an embodiment of the invention. With reference to FIG. 11, a physical counter 1120 is disposed beside the information displaying apparatus 1000, and there is an operator 1160 behind the physical counter 1120. In this embodiment, the operator 1160 behind the physical counter 1120 may serve the clients through the virtual clerk 1070 displayed by the information displaying apparatus 1000. More specifically, if the user is interested in the object 420 and wishes to know more information about the object 420, the information displaying apparatus 1000 notifies the operator 1160 (for example, by displaying a notification on a second screen (not shown) at the rear side of the information displaying apparatus 1000). The operator 1160 then converses with the user 1190 through a microphone 1110, and the virtual clerk 1070 executes an action corresponding to the contents of the conversion or corresponding to a received command. The operator 1160 may also speak through the speaker 1020.

In the above embodiment, the consumer obtains the required information easily and freely. In addition to providing the product information, the information displaying apparatus 100 of the invention may also be integrated with a selling mechanism, allowing the consumer to purchase the product at the information displaying apparatus 100.

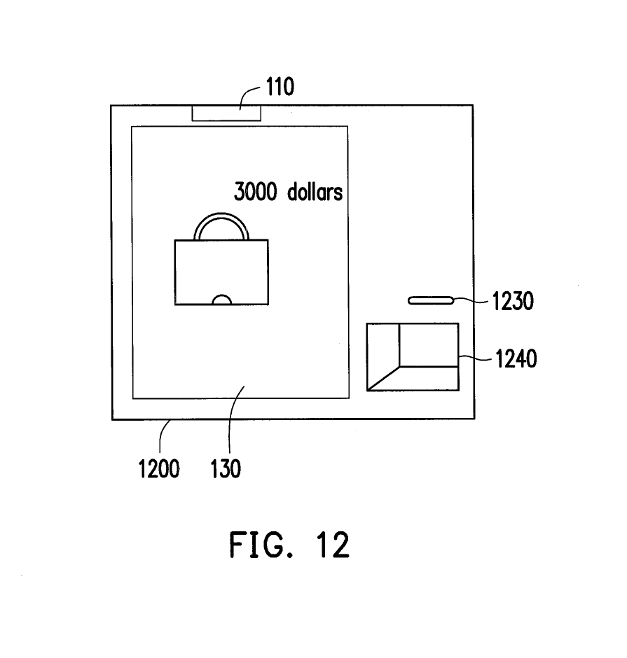

For example, FIG. 12 is a schematic diagram illustrating an information displaying apparatus according to another embodiment of the invention. With reference to FIG. 12, an information displaying apparatus 1200 of FIG. 12 corresponds to the information displaying apparatus 100 of FIG. 2, and a difference therebetween lies in that the information displaying apparatus 1200 further includes a payment device 1230 and an object delivery portion 1240. The processor 170 (not shown) displays payment information (e.g. 3000 dollars) related to the object 420 via the first screen 130. After the payment device 1230 collects the money, the processor 170 determines whether an amount of the payment made by the user is greater than or equal to a price of the object 420 and then outputs the object 420 to the object delivery portion 1240.

The virtual clerk 1070 of the above embodiment is able to provide the consumer the consulting service. However, the virtual clerk 1070 may not be able to provide full services (e.g. services of checking out and packaging products, etc.). In an embodiment, the information displaying apparatus 100 of the invention transfers services that the virtual clerk 1070 cannot provide to a clerk at the physical counter.

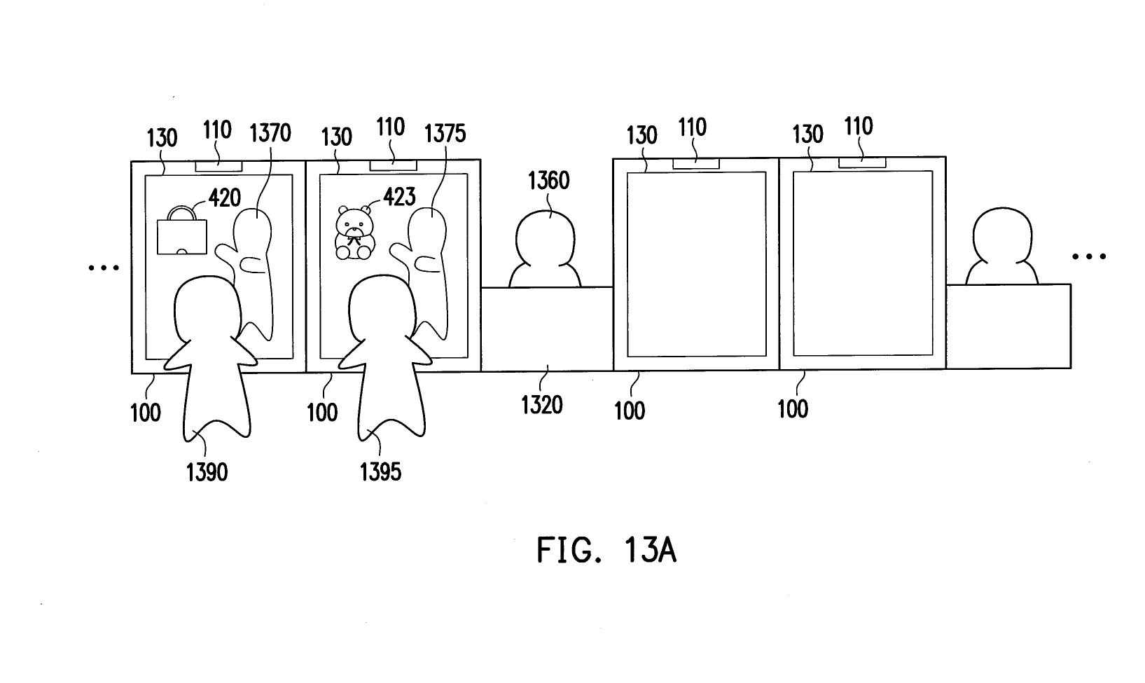

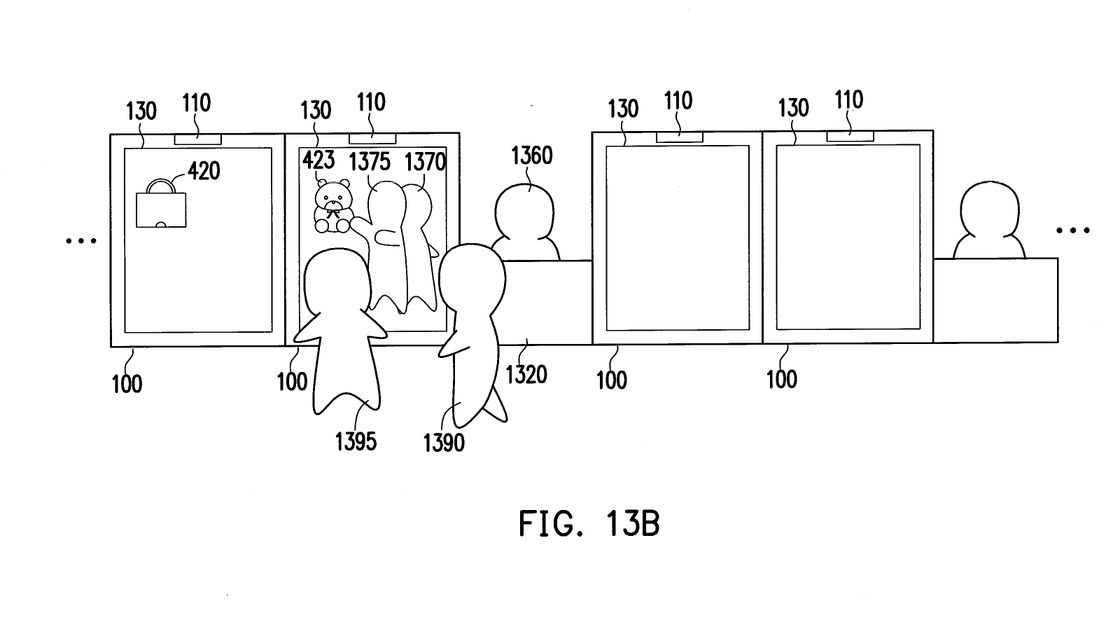

For example, FIG. 13A and FIG. 13B are schematic diagrams illustrating a combination of the information displaying apparatus 100 and the physical counter according to another embodiment of the invention. Please refer to FIG. 1 and FIG. 2 for detailed descriptions of the information displaying apparatus 100 shown in FIG. 13A and FIG. 13B. With reference to FIG. 13A, a plurality of information displaying apparatuses 100 are disposed in a row, and physical counters 1320 are respectively disposed between part of the information displaying apparatuses 100. The physical counter 1320 shown in FIG. 13A may also be disposed at a different position. For instance, three information displaying apparatuses 100 may be provided with one physical counter 1320. Thus, the disclosure here is not intended to limit the position of the physical counter 1320 of this embodiment.

The processor 170 of the information displaying apparatus 100 on the left side of FIG. 13A displays a virtual clerk 1370 via the first screen 130 thereof and the processor 170 of the information displaying apparatus 100 on the right side also displays a virtual clerk 1375 via the first screen 130 thereof. The other information displaying apparatuses 100 display virtual clerks accordingly. For example, when a user 1390 decides to buy the object 420, the user 1390 may select a purchase option displayed on the first screen 130 of the information displaying apparatus 100. The motion detector 110 of the information displaying apparatus 100 then detects an operation of the user 1390. After confirming that the user wishes to buy the object 420, the processor 170 displays a corresponding image via the first screen 130. With reference to FIG. 13B, the first screen 130 of the second information displaying apparatus 100 on the left side displays that the virtual clerk 1370 is walking toward the physical counter 1320 and passing behind the virtual clerk 1375.

The clerk 1360 at the physical counter 1320 undertakes the consulting service from the virtual clerk 1370 and continues to provide sales services regarding the specific object 420 according to the information of the specific object 420 provided by the information displaying apparatus 100. More specifically, when the user 1390 selects to purchase the object 420 via the first screen 130, the processor 170 notifies the clerk 1360 at the physical counter 1320 of the purchase made by the user 1390. For example, the physical counter 1320 has a second screen, which displays information that the user 1390 selects to purchase the object 420, so that the clerk 1360 learns the information about the object 420 immediately. When the first screen 130 displays that the virtual clerk 1370 leaves the first screen 130 of the virtual clerk 1375, the clerk 1360 follows the virtual clerk 1370 to provide sales services (e.g. packaging and checking out) with respect to the object 420.

In other embodiments of the invention, the information displaying apparatus 100 may also be used in combination with a logistics service provider. For example, if the consumer does not wish to pick up the product in person and selects home delivery, the information displaying apparatus 100 may connect to a website of the logistics service provider via the network unit so as to inform the logistics service provider to come pick up the product for delivery.

In conclusion of the above, the information displaying apparatus described in the above embodiments of the invention displays multiple objects for the user's selection and detects the selection operation of the user to display interactive images and display a variety of information about the selected object, e.g. product composition, utility, production place, promotional activity and/or brand name/corporate vision, etc. Therefore, the consumer is able to review all the products to obtain sufficient product information through the information displaying apparatus of the invention. Moreover, the pressure the consumer feels is reduced, and thus the consumer can shop at ease.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. An information displaying apparatus for objects, comprising:
a first screen;
a motion detector;
a storage unit comprising a database having a variety of information about a plurality of objects; and
a processor coupled to the first screen, the motion detector, and the storage unit,
wherein the first screen displays any number of the plurality of objects; the motion detector detects a first operation action of a user; and the processor displays an interactive image corresponding to the first operation action via the first screen according to the first operation action, determines whether the first operation action is to select a specific object among the plurality of objects, and searches the database to display information about the specific object via the first screen.

2. The information displaying apparatus according to claim 1, wherein the information about the specific object comprises one of object composition, object utility, production place of object, promotional activity, and corporate vision, or a combination of the foregoing.

3. The information displaying apparatus according to claim 1, wherein the first screen displays the information about the specific object by a plurality of pages.

4. The information displaying apparatus according to claim 3, wherein the motion detector detects a second operation action of the user, and the processor opens or reduces a first page that is being reviewed by the user via the first screen according to the second operation action.

5. The information displaying apparatus according to claim 3, wherein the first screen displays a perspective image of the specific object, and the processor displays and rotates the perspective image according to the second operation action detected by the motion detector.

6. The information displaying apparatus according to claim 1, wherein the processor further displays a virtual clerk via the first screen according to the specific object for providing a consulting service regarding the specific object.

7. The information displaying apparatus according to claim 6, further comprising:
a physical counter, wherein an operator at the physical counter serves clients through the virtual clerk displayed by the information displaying apparatus.

8. The information displaying apparatus according to claim 1, wherein a plurality of the information displaying apparatuses are disposed in a row; a plurality of physical counters are respectively disposed between part of the plurality of information displaying apparatuses; the processor of each of the plurality of information displaying apparatuses displays a virtual clerk via the first screen thereof; and a clerk at one of the plurality of physical counters undertakes the consulting service from the virtual clerk and continues to provide sales services regarding the specific object according to the information about the specific object provided by the information displaying apparatus.

9. The information displaying apparatus according to claim 1, wherein the processor further displays payment information related to the specific object via the first screen, and the information displaying apparatus further comprises:
a payment device adapted for collecting money; and
an object delivery portion, wherein the processor determines whether an amount of a payment made by the user is greater than or equal to a price of the specific object and outputs the specific object to the object delivery portion.

10. The information displaying apparatus according to claim 1, further comprising:
a network unit, by which a network is connected to obtain the information about the specific object, and the information about the specific object is stored in the database.

11. An information displaying method for objects, comprising:
displaying a plurality of objects via a first screen, wherein a variety of information about the plurality of objects is stored in a database;
detecting a first operation action of a user by a motion detector;
displaying an interactive image corresponding to the first operation action via the first screen according to the first operation action;
determining whether the first operation action is to select a specific object among the plurality of objects; and
searching the database to display information about the specific object via the first screen.

12. The information displaying method according to claim 11, wherein the information about the specific object comprises one of object composition, object utility, production place of object, promotional activity, and corporate vision, or a combination of the foregoing.

13. The information displaying method according to claim 11, wherein a step of displaying the information about the specific object comprises:
displaying the information about the specific object by a plurality of pages.

14. The information displaying method according to claim 13, further comprising the following steps after the step of displaying the information about the specific object:
detecting a second operation action of the user; and
opening or reducing a first page that is being reviewed by the user via the first screen according to the second operation action.

15. The information displaying method according to claim 14, further comprising the following steps after a step of detecting the second operation action of the user:
displaying a perspective image of the specific object; and
displaying and rotating the perspective image according to the second operation action detected by the motion detector.

16. The information displaying method according to claim 11, further comprising the following step after the step of displaying the information about the specific object:
displaying a virtual clerk via the first screen according to the specific object for providing a consulting service regarding the specific object.

17. The information displaying method according to claim 16, further comprising the following step after the step of displaying the information about the specific object:
providing the virtual clerk displayed by an information displaying apparatus so that an operator at a physical counter serves clients through the virtual clerk.

18. The information displaying method according to claim 11, wherein a plurality of information displaying apparatuses are disposed in a row and a plurality of physical counters are respectively disposed between part of the plurality of information displaying apparatuses, and the information displaying method further comprises the following after a step of displaying the information about the specific object by the plurality of information displaying apparatuses:
displaying a virtual clerk via the first screen;
a clerk at one of the plurality of physical counters undertaking the consulting service from the virtual clerk; and
providing sales services regarding the specific object according to the information about the specific object provided by the information displaying apparatus.

19. The information displaying method according to claim 11, further comprising the following steps after the step of displaying the information about the specific object:
displaying payment information related to the specific object;
collecting money by a payment device; and
determining whether an amount of a payment made by the user is greater than or equal to a price of the specific object and outputting the specific object.

20. The information displaying method according to claim 11, further comprising the following step before a step of searching the database:
connecting to a network to obtain the information about the specific object; and
storing the information about the specific object in the database.
